(19) United States
(12) Patent Application Publication
(10) Pub. No.: US 2008/0057596 A1
(43) Pub. Date: Mar. 6, 2008

(54) Colorimetric determination of somatic cell count in milk

(76) Inventors: Wai Tak Law, Moorestown, NJ (US); Robert Douglas Harper, Marlton, NJ (US)

Correspondence Address: DONALD C. SIMPSON, 126 BORTON LANDING ROAD, MOORESTOWN, NJ, 06057-3056, US

(21) Appl. No.: 11/512,498

(22) Filed: Aug. 30, 2006

(51) Int. Cl. G01N 21/75

(52) U.S. Cl. 436/166

(57) ABSTRACT

The invention involves using a simple colorimetric method for a quantitative test to measure white blood cells in milk samples. The invention includes a new reagent system, a new analysis method, and a new apparatus which permits in-line colorimetric analysis.

### BACKGROUND OF THE INVENTION:

Mastitis is an inflammation of the mammary gland in an animal's udder that costs the dairy industry great economic loss. The dairyman generally is aware of clinical mastitis because a swollen udder can be observed, or the milk is watery, thick or ropy. Unfortunately, an apparently healthy animal can harbor sub-clinical mastitis, which makes up about 70% of the mastitis in dairy herds. Infections may continue for weeks before abnormal milk or soreness of the udder is observed. Mastitis in dairy herds is a major contributor to decreased milk quality and many believe that mastitis is a food safety and animal welfare issue.

Current practice for controlling mastitis is to monitor the Somatic Cell Counts (SCC) of milk samples from bulk tanks or from individual cows. Samples are collected and sent to laboratories for quantitative assays using specialized instruments such as flow cytometers. The instruments used are usually large and costly, and requiring trained personnel to operate. The turn around time for these assays is usually days.

SCC in milk has become the universal means of screening and monitoring mastitis. Bulk tank milk somatic cell counts (BTSCC) are a measure of the prevalence of mastitis in a dairy herd, and are used by regulatory agencies as an indicator of the wholesomeness, safety and suitability of raw milk for human consumption. The upper limit for BTSCC establishes the amount of abnormal milk tolerated in the supply. The European Union, New Zealand, Australia, Switzerland, Norway and Canada all accept 400,000 cells/mL as the upper limit, while the United States is 750,000 cells/mL. SCC are commonly measured off-line in laboratories. The traditional, available cow-side test is the California Mastitis Test (CMT). The CMT reagent is a detergent with a color indicator added. When milk and the reagent are mixed in equal amounts, the reagent dissolves or disrupts the outer cell wall and the nuclear cell wall of any white blood cell (WBC), releasing DNA that gels to form a stringy mass. As the number of WBC increase, the amount of gel formation will also increase. The gel formation is then scored or read for possible infection. The CMT reagent is inexpensive, but the test results are highly user-dependent, and the sensitivity of the method is low, while the false positive rate is sometimes as high as 50%.

Electrical conductivity methods, such as the MAS-D-TEC® device, are an electrode based system that can measure conductivity of milk sample at the cow-side. The principle of this test is based on the observation that milk electrolytes such as sodium and chloride increase when SCC is high. The test is simple to use, but has the drawback of low sensitivity and requires individual calibration for each cow.

New generations of cow-side testing have also been commercialized. They are represented by the nine pound DeLaval cell counter DCC (not an abbreviation) that uses a disposable test cassette to estimate cell counts by digital imaging (U.S. Pat. No. 6,919,960), and the PortaSCC® milk test and reader (PortaCheck, a division of PortaScience Inc.) that estimates WBC counts by an enzymatic reaction (U.S. Pat. No. 6,709,868). These analyzers have enabled users to obtained quantitative SCC data quickly at the cow-side, and are useful tools for the management of mastitis. However, these cow-side tests still require manual labor to run.

Many attempts have been made to bring faster testing to the cow-side. The recent introduction of automatic milking systems (AMS) have the potential to enhance quality of life for dairy producers and their cows, as well as increase milk production and milk quality. Dairy farm sizes are also increasing with time, with the increasing need for better management of the cows. There has been increasing interest in the development of new in-line sensors. In-line SCC sensors are designed to take samples directly from the milking lines and measure signals that may reflect the health of an animal. This approach will be ideal for evaluating up-to-date data for each animal in real time. The measurements of milk color and conductivity are the two most popular methods being adapted to in-line measurements. The color sensor measures the presence of the red color of blood. The presence of blood usually indicates symptoms of clinical mastitis. As infection occurs, salts and ions also come out of the inflamed, damaged tissues and leak into the milk. In solution, ions enable the flow of electricity, so the more leaked ions, the greater the conductivity. Consequently, changes in conductivity can be indicators of SCC. Robar (U.S. Pat. No. 3,989,009) taught about the use of conductivity measurements to estimate bovine mastitis. The use of conductivity sensors has been thoroughly investigated and results are not satisfactory. Not all mastitis cases show increases in electrical conductivity of milk and in addition, many increases in conductivity may not be due to mastitis, resulting in a great number of false positives. In most cases, instruments based on color or conductance can only alert the dairymen the presence of clinical mastitis.

Sensortec in New Zealand has developed an in-line Somatic Cell Count Sensor based on CMT technology. They have automated and standardized the viscosity measurement of DNA-gel formation. The rate of flow of gel formed from a mixing chamber into waste chamber is proportional to DNA, which is proportional to SCC. There are several disadvantages to this system—these include clogging of orifices, milk reological differences due to protein and fat content, and length of assay. This method also requires a rather specialized instrument and produces only semi-quantitative SCC measurements in 5 ranges.

Other technologies for in-line SCC measurements have also been reported. Hansen (U.S. Pat. Nos. 6,731,100, 6,919,960) described a method that labels the cells with stain and estimates cell counts by a detection element such as CCD array. This method is similar to the flow counting method but not suitable for in-line SCC measurements. Tesnkova (U.S. Pat. No. 6,793,624) presented a method of using irradiating light in a wavelength range of 400-2,500 nm, together with multivariant analysis to diagnose the presence of mastitis in cows. The method would have been an ideal non-contact sensor. However, this method was found to be highly affected by interfering substances. Mangan (U.S. Pat. No. 6,307,362) described an in-line SCC analyzer using sodium ion measurement. Like conductivity measurements, the correlation to SCC was low. Both Tassitano (U.S. Pat. No. 5,628,964) and Bullock (U.S. Pat. No. 4,376,053) taught the use of an in-line filter or release mechanism to detect clot formation These methods are only suitable for picking up milk samples that exhibit severe clinical mastitis symptoms.

There remains a need for a simple, in-line, accurate cow-side test for the quantitative determination of SCC.

### BRIEF SUMMARY OF THE INVENTION

The invention involves using a simple colorimetric method for a quantitative test to measure white blood cells in milk samples. The invention includes a new reagent system, a new analysis method, and a new apparatus which permits in-line colorimetric analysis.

### BRIEF DESCRIPTION OF THE DRAWINGS

FIG. 1 is a schematic of an embodiment of the in-line apparatus of the present invention.

FIG. 1(a) is a schematic enlargement of the signal portion of the embodiment of FIG. 1 which utilizes light transmission.

FIG. 2 is a graphical representation of the data of Example 1 as summarized in Table 1 of that Example.

FIG. 3 is a schematic enlargement of a preferred signal portion for the embodiment of FIG. 1 in which the light transmission signal system is replaced by a light reflectance signal system.

FIG. 4 is a graphical representation of the data obtained from Example 3.

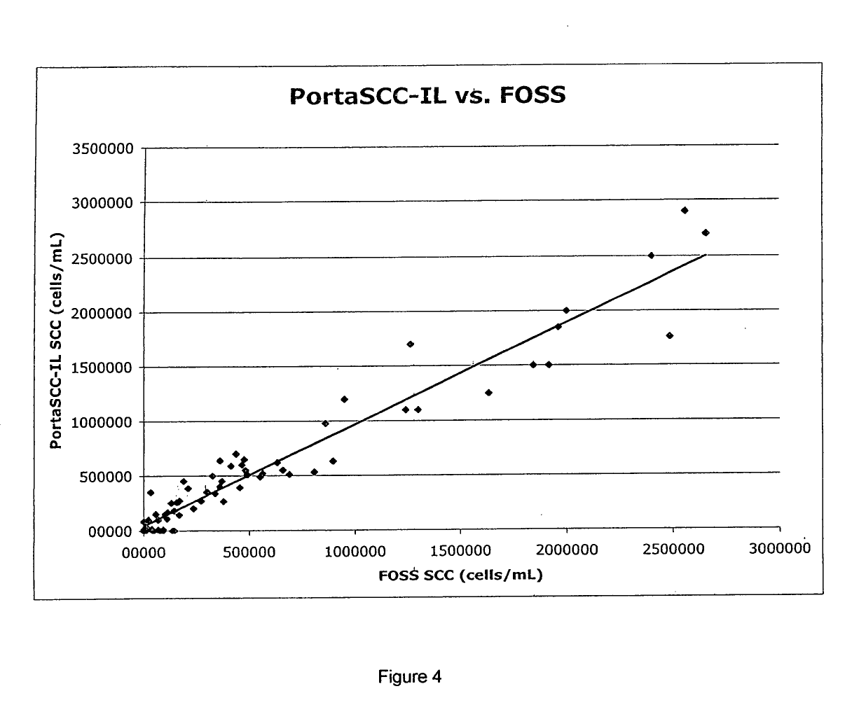

### DETAILED DESCRIPTION OF THE INVENTION

Since over 90% of somatic cells are WBC or leukocytes, the proposed method will directly determine the somatic cell count, yielding quantitative results of individual milk at the cow-side. The proposed analytical system will use an inexpensive photometer and liquid reagents for detection, and will produce accurate quantitative SCC measurements in approximately one minute per assay.

All somatic cells or leukocytes have an enzyme called esterase on their cell wall. The role of the polymorphonuclear leucocytes esterase is to convert acetates to phenols. Over the years, urine test-strips have been used to detect the presence infection by indicating the presence of leukocytes in the urine. However, due to the interferences in sample matrixes such as blood and milk, no field test for leukocytes was available until PortaScience published a new technology in 2004. The novel SCC milk test was based on a solid phase test format, and a new dye substrate, 3-(N-tosyl-L-alaninyloxy)-indol (Taloxin) (U.S. Pat. No. 6,709,868), which is very sensitive to esterase, yielding a strong blue color in the presence of esterase. The enzyme catalyses the hydrolysis of dye-substrate, and forms an indigo blue colored dye as the reaction product. Many other colorless chromogenic esters known in the art may be cleaved by the same enzymatic hydrolysis (U.S. Pat. Nos. 4,278,763; 4,637,979; 4,657,855; 4,716,236; 4,806,423).

The concentration of leukocytes and WBC in milk (SCC) is proportional to the enzyme esterase presence, which is proportional to the end color intensity of the indigo dye. This enzymatic reaction has been commercialized successfully for semi-quantitative measurement of leukocytes in urine (U.S. Pat. No. 4,278,763), and recently a quantitative solid phase cow-side test—the PortaSCC milk test—has also been commercialized (U.S. Pat. No. 6,709,868). Potentially this method is an excellent candidate for the development of an in-line SCC test. However, because of the solubility of the dye substrate and the interferences in the milk sample, no liquid reagent using this principle was ever reported for an in-line application. It was surprising, therefore, to find that we have identified a new surfactant and buffer system that accelerates the reaction and reduced interferences, allowing for a rapid detection of SCC (<90 seconds) in liquid phase. We also found that a simple LED/silicon detector optical system was able to measure the resulting color changes quantitatively, allowing for the first time a simple and inexpensive in-line SCC measurement system to be constructed.

The active reagent of the invention consists of a single colorimetric system that contains a dye substrate and buffer (the preferred embodiment) or two part colorimetric system that contains a dye substrate component and a separate buffer component. The preferred dye substrate used in the reagent system is a member of the indoxyl ester family, such as 3-acetyl indoxyl and 3-(N-tosyl-L-alanyloxy)-indole. However, any known substrate that can be hydrolyzed by the esterase on white blood cells to form a colored dye can be use. The buffer works best at a pH of greater than 9.0, but can be functional between pH 7.0-11.0 and at concentrations between 0.01 M to 2 M. A representative and preferred buffer is Tris(hydroxymethyl)aminomethane, commonly referred to as “Tris”. The dye substrate is dissolved in low molecular weight alcohols such as methanol, ethanol, or isopropanol. A surfactant such as the non-ionic surfactant Triton×100 helps to disperse the cell components in the assay mixture, and many other non-ionic, anionic, or cationic surfactants are suitable for this purpose.

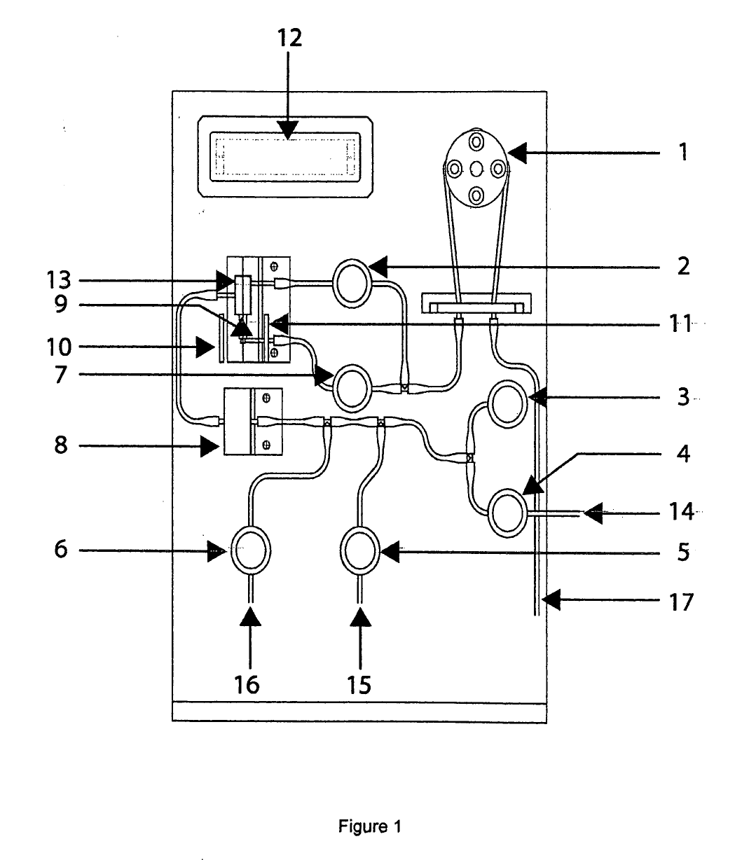

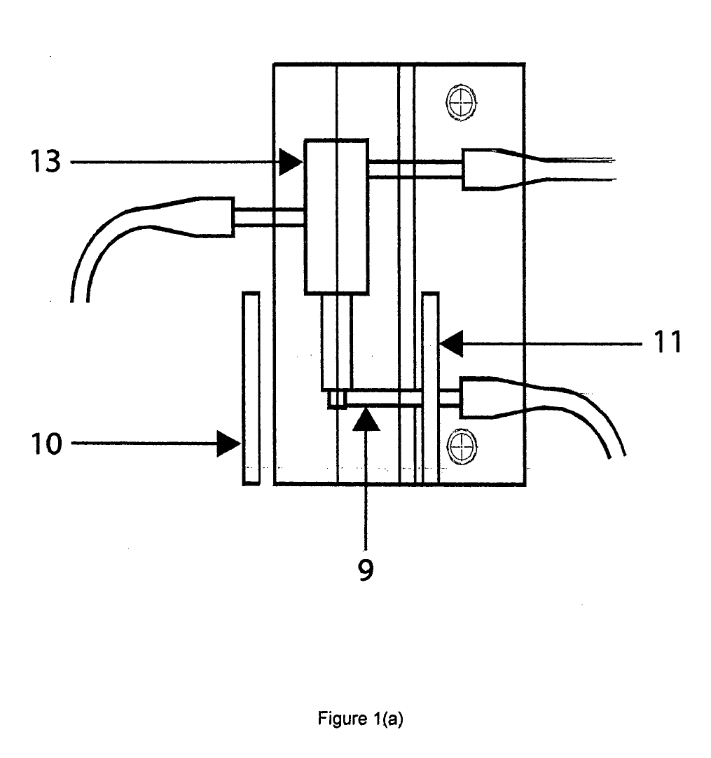

The in-line analyzer of the invention consists of a fluid control system, an optical detection system, and related electronics and display, see FIG. 1. Optionally, a temperature control system can be added to the system.

### EXAMPLE 1

### Liquid Reagent for SCC Determination

The reagent component of the invention consists of the following formulation:

### 3-(N-tosyl-L-alanyloxy)-indole 10 mg/mL

| | |
|---|---|
| Tris buffer | 1 molar, pH 9.8 at 24° Celsius |
| Isopropanol | 200 mg/mL |
| Triton X-100 | 15 mg/mL |

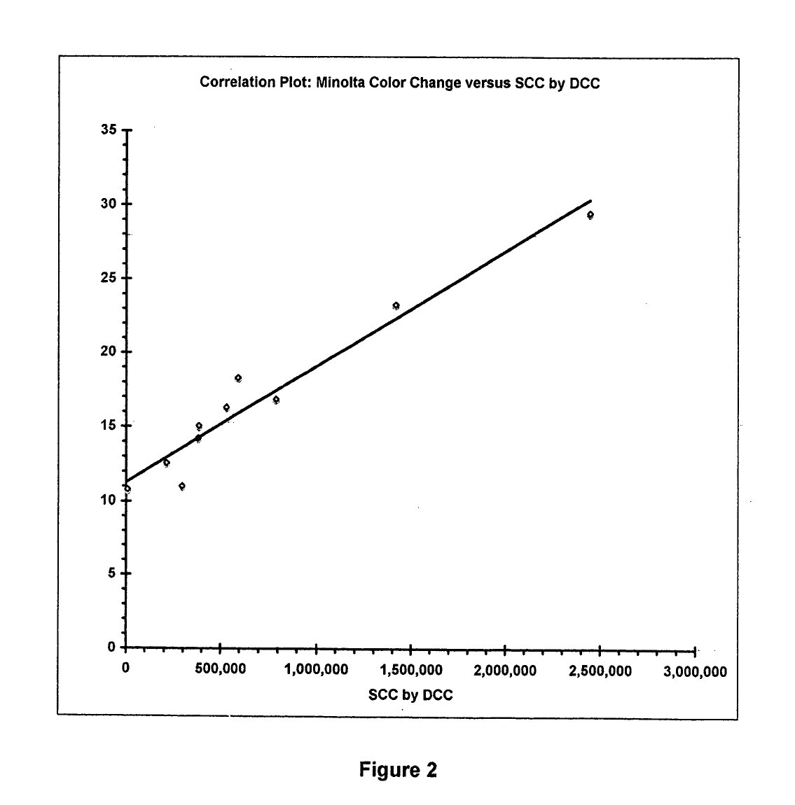

Ten fresh milk samples were collected for this study. One hundred microliters of the reagent is mixed with 100 μL of fresh milk sample, and the color changes measured by a Minolta CR-321 colorimeter in Hunter's units in 180 seconds were plotted against the Deleval's Direct cell counter (DCC) method. The data is summarized in Table 1, and the correlation shown in FIG. 2.

TABLE 1
Correlation of the Present In-Line method versus DCC

| | | Minolta Color |
|---|---|---|
| Sample | SCC by DCC | Change |
| 1 | 7,000 | 10.8 |
| 2 | 214,000 | 12.57 |
| 3 | 382,000 | 14.22 |
| 4 | 530,000 | 16.3 |
| 5 | 1,417,000 | 23.3 |
| 6 | 385,000 | 15.05 |
| 7 | 790,000 | 16.85 |
| 8 | 2,445,000 | 29.45 |
| 9 | 593000 | 18.31 |
| 10 | 295,000 | 11.03 |

### EXAMPLE 2

### In-Line SCC Determination (Transmittance Mode)

The milk sample from a milking line is introduced to the in-line instrument module by a pump and a series of valves, where it is mixed with the reagent. After a fixed incubation period, the mixture is moved to an optical flow cell, where the color intensity is read. The schematic of the in-line instrument is shown in FIG. 1.
1. Fluidic controls—The instrument design has one peristaltic pump 1 and six valves 2 through 7 controlling sample and reagents measurements, mixing, and washing steps required in the assay protocol. The peristaltic pump was selected over direct drive pump because of the proven reliability and low cost. The number of valves can be reduced to three, but using six valves simplifies the design of the sequencing for the initial prototype. Similarly, the number of pumps used can be increased to three or more, and other fluidic controls such as positive displacement syringes can be added to increase the accuracy of the fluidic controls. The instrument also should have available a reagent bottle, a buffer bottle, and a waste bottle.
2. Optical detection—Instead of using expensive precision pipetting system for measuring the volumes of fluids, a bubble detector 8 was used to measure exact volumes of samples and reagents. The different segments of fluids was separated by columns of air (bubbles), and by measuring the leading or the ending edges of these bubbles, we were able to measure accurate volumes of fluids with a light emitting diode (LED)based detector inexpensively. However, another simple way of measuring the volumes of fluids was simply counting steps of the motor. An optical flow cell 9 with a path length of 3 mm, an emitter board 10, and a sensor 11, for example, a silicon detector, is used to measure the optical intensity of the color of the reaction mixture. A detailed diagram of the optical module is shown in FIG. 1a. A liquid crystal display (LCD) display 12 displays the SCC as a digital read out. Off-the-shelf electronic control boards were used to control the fluid movements and the signal processing.
3. Optional Temperature control—A temperature controlled heating element was designed into the back of the flow cell. The purpose was to keep the assay temperature constant at 37° or 40° Celsius. Since the principle of the reagent is enzymatic based, keeping a constant reaction temperature will ensure the accuracy of the test. A side benefit of running the reaction at slightly elevated temperature is the increase in the reaction rate, which in turn will help decrease the assay time.

The in-line protocol using a flow cell is summarized as follows:
(1) A 100 μL sample of milk is introduced into a mixing chamber 13.
(2) Next a 100 μL aliquot of buffer/surfactant solution is introduced.
(3) Followed by 40 μL of dye substrate.
(4) The solution is mixed for 60 seconds in the mixing chamber.
(5) The solution is moved to the optical flow cell [9] and read. Color intensity is proportional SCC count.
(6) A 500 μL aliquot of buffer washes the flow cell into waste.
(7) Steps 1 through 6 are repeated with a 60-180 second turn around for each cow.

### EXAMPLE 3

### In-Line SCC Determination (Reflectance Mode)

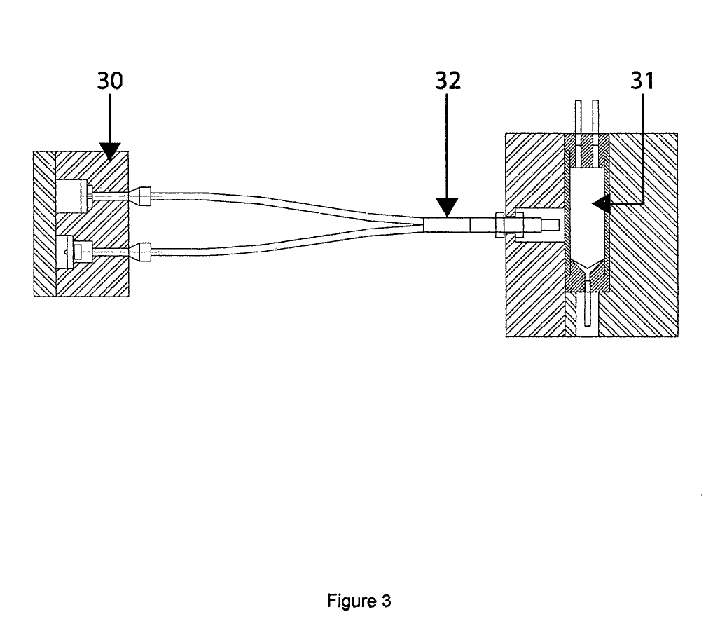

The optical detection module of the in-line SCC instrument was modified using the same flow cell and fluidic controls but the optical detector was changed. The optical signal change was measured by a reflectance mode rather by the transmittance mode. As shown in FIG. 3, the emitter 30 and the sensor were placed on the same side of the optical flow cell. The light source was directed to the flow cell surface by a fiber optics 32, and the reflectance measurement was guided back to the sensor using the same optical fiber bundle. The angle of reflectance measurement was 180 degree in this example, but could be optimized by setting the optical fiber at another angle. The light intensity reflected from the surface of the milk and reagent mixture inside the flow cell 31 was measured. Data were collected for 30,60,90,120, and 180 seconds assay times. A standard curve was constructed using the reflectance mode using the 180 seconds assay time. Seventy fresh milk samples were assayed using this method against the reference laboratory FOSS method, and the correlation plot is shown in FIG. 3.

1. A reagent system for the colorimetric determination of somatic cell count in milk comprising a dye substrate that can be hydralized by the esterase on white blood cells to form a colored dye dissolved in a low molecular weight alcohol and a buffer in concentrations between 0.01 M to 2M and adapted to maintain the system at a pH in the range of 7.0 to 11.0.

2. A reagent system in accordance with claim 1 additionally including a surfactant capable of dispersing the cell components of milk in an assay mixture.

3. A reagent system in accordance with claim 1 in which said reagent system consists of a mixture of said dye substrate and said buffer.

4. A reagent system in accordance with claim 2 in which said reagent system consists of a mixture of said dye substrate and said buffer and in which said surfactant is admixed with said dye substrate and said buffer.

5. A method for the determination of the somatic cell count in milk comprising mixing a milk sample to be analyzed with a reagent system for the colorimetric determination of somatic cell count in milk comprising a dye substrate that can be hydralized by the esterase on white blood cells to form a colored dye dissolved in a low molecular weight alcohol and a buffer in concentrations between 0.01 M to 2M and adapted to maintain the system at a pH in the range of 7.0 to 11.0, and measuring the colorimetric change in the milk sample.

6. A method in accordance with claim 4 wherein, said reagent system additionally contains a surfactant capable of dispersing the cell components of milk in an assay mixture.

7. An apparatus for the in-line colorimetric determination of the somatic cell count in milk comprising in combination a peristaltic pump, a mixing chamber, a supply of dye substrate reagent, a supply of buffer, means for delivering the dye substrate and said buffer to said mixing chamber, a separate means for delivering a milk sample for analysis to said mixing chamber after said substrate and said buffer have been mixed, and means for measuring colorimetric change of the reagent buffer-milk mixture.

8. An apparatus in accordance with claim 7 in which said means for measuring the colorimetric change is a means for reading color change by the transmission of light through the sample.

9. An apparatus in accordance with claim 7 in which said means for measuring the colorimetric change is a means for reading color change by the reflectance of light from the sample.
